(19) United States
(12) Patent Application Publication
(10) Pub. No.: US 2010/0046866 A1
(43) Pub. Date: Feb. 25, 2010

(54) GAS THRUST BEARING AND BEARING BUSH THEREFOR

(75) Inventor: Jan-Grigor Schubert, Senden (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/513,535

(22) PCT Filed: Oct. 30, 2007
(86) PCT No.: PCT/EP07/61666

§ 371 Date: May 5, 2009

(30) Foreign Application Priority Data
Nov. 7, 2006 (DE) 10 2006 052 427.6

(51) Int. Cl. F16C 32/06

(52) U.S. Cl. 384/105

(57) ABSTRACT

A gas thrust bearing including a bearing bush and a housing accommodating the bearing bush. The bearing bush includes a bush body defining a longitudinal axis. The bush body includes a plurality of recesses formed on an outer surface of the bush body, and a plurality of capillary holes extending from a floor of each recess of the plurality of recesses through the bush body to an inner surface of the bush body. A cross section of the bush body transverse to the longitudinal axis, through each of the plurality of capillary holes, has a local wall thickness that is greater than a wall thickness in an immediate environment of the capillary hole.

The present invention relates to a gas thrust bearing in accordance with the preamble of claim 1 as well as to a linear compressor in which the gas thrust bearing is used.

Radially-acting gas thrust bearings accept radial forces acting on a body such as a shaft or a piston held movably in a bearing bush, by directing pressurized gas evenly through small holes in the wall of the bearing bush into a gap between body and bush, so that the cushion of gas produced prevents body and bearing bush from touching each other.

If a radially-acting force shifts the body radially in relation to the bearing bush, the gap between body and bearing bush narrows in the direction of the force, and the gas cushion in the narrowed area of the gap is compressed, while an area of the gap on the opposite side of the body becomes wider and the gas cushion expands accordingly in said area. This pressure difference produces a return force, which becomes greater as the radial deflection of the body and thereby the pressure difference between the two areas of the column becomes stronger (spring effect). The strength of the spring effect (stiffness) of a gas thrust bearing is essentially determined by the cross-section of the supply holes. The smaller these holes are the more effectively the gas is prevented from flowing back. The smaller the flowback effect, the stronger is the increase in pressure through the radial displacement of the body, and therefore the higher is the return force (stiffness).

The smaller is the diameter of the supply holes, the smaller is the gas throughput required through the supply holes sufficient for a satisfactory bearing effect. A minimization of the gas throughput is of greater significance especially for applications such as the support of a compressor piston, in which gas compressed by the compressor itself is used for operation of the gas thrust bearing and a high gas consumption adversely affects the efficiency of the compressor.

It is also desirable for different reasons to make the diameter of the supply holes in a bearing bush of a gas thrust bearing as small as possible.

Hole diameters in the range of less than a hundredth of a millimeter can nowadays be made efficiently with pulsed laser beams or with spark erosion. In such cases however the aspect ratio of the hole (diameter d in relation to hole length L) plays a particular role as regards quality and cost-effectiveness of the hole. For industrial production the prior art is currently an aspect ratio of maximum 1:20. A higher aspect ratio of up to 1:40 is able to be achieved under some circumstances with a suitable choice of material, however only at the expense of the accuracy of repeating the holes.

Assuming a practically realizable diameter d of the supply holes of 30 μm and an aspect ratio 1:20, the wall thickness L of the bush may not exceed 0.6 mm. The mechanical processing of such a thin-walled bush is extremely difficult, since the forces required for mounting and machining can very easily deform the high-precision bush. One approach to a solution which improves the dimensional stability of the bush yet still makes it possible to form narrow supply holes is to turn a groove running around the outer surface on a original thick-walled bush, with the wall thickness of the bush being reduced in the area of the groove, and subsequently the supply holes being formed on the floor of the groove. However the problem arising here is that the very thin-walled bush in the area of the groove is in danger of being deformed by the forces arising during machining. In practice this forces such a high residual wall thickness to be also retained in the area of the groove that supply holes able to be made reproducibly with an aspect ratio of appr. 1:20 have a undesired large diameter or holes with a higher aspect ratio and a restricted reproducibility must be made, which lead to an uneven distribution of the gas cushion between the bearing bush and the body supported within it and thus to a bearing effect of limited reliability.

The object of the present invention is to specify a bearing bush having reproducible narrow supply holes and a high dimensional stability, as well as specifying applications for such a bearing bush.

The object is achieved by a gas thrust bearing with a housing featuring a bearing bus having a bush body which defines a longitudinal axis and a plurality of recesses formed on the outer surface of the bush body and a plurality of capillary holes extending in each case from the floor of one of these recesses through the bush body to an inner surface of the same, which is characterized in that the bush body, in each section running transverse to the longitudinal axis through one of the capillary holes, has a higher local a higher wall strength than in the immediate vicinity of the hole. Whereas with the conventional bearing bush the groove running around it has a low wall strength which remains the same over the entire cross-section, the inventive locally increased wall strength makes it possible to increase the load on the bearing bush especially in relation to torque with a torque vector in parallel to the longitudinal axis.

According to a first embodiment of the invention the recesses are blind holes in each case, of which the diameter is greater than that of the capillary holes, and the capillary holes start from the floor surface of each blind hole in each case.

With this embodiment a very high dimensional stability of the bearing bush is implemented, since a high wall strength of the bush body outside the blind holes can be selected as required. The manufacture of this bearing bush is however comparatively complex, since each supply hole extending through the bush body must be created in two steps, first the creation of the blind hole and subsequently the creation of the capillary hole and during the creation of the blind hole the hole depth must be monitored with high accuracy.

In accordance with a simple-to-manufacture embodiment the recesses are segment-shaped cutouts on the cylindrical outer surface of the sleeve. These are easy to manufacture with the same depth, in that for example the bearing bush is placed on a processing table and drawn over a circular saw blade or a milling head, the height of which above the table surface is slightly smaller than the wall thickness of the bush body.

A capillary hole in this embodiment preferably starts in a section transverse to the longitudinal axis centrally in each case from a floor surface of the cutout, since the remaining wall thickness is at its lowest there.

It is also expedient for a number of said cutouts in each case to coalesce into a groove running around the outer surface, since then a single supply inlet communicating with the groove is sufficient to feed compressed gas to all capillary holes exiting from the groove.

In cross section the floor surfaces of the cutout preferably form a regular polygon.

Not only in the case of the segment-shaped cutouts mentioned above is it expedient for the recesses to be part of at least one groove running around the outer surface with a depth which varies in the circumferential direction, in order to make possible a common compressed gas feed to all capillary holes exiting from the groove.

According to a further preferred embodiment, the bush body, in a section transverse to the longitudinal axis, has the shape of a toothed wheel, with one of the capillary holes starting in each case from a tooth gap of the toothed wheel shape.

In cross section the teeth and tooth gaps preferably form a curved contour.

The toothed wheel shape, especially a toothed wheel shape with curved contour, is obtained by turning with an oscillating rotary milling tool.

For a gas thrust bearing with a bearing bush of the type described above and a housing accommodating the bearing bush at least one channel is preferably embodied on an inner surface of the housing, via which a number of the recesses communicate, to make possible a common compressed gas feed to the number of recesses.

The channel is preferably extended in the direction of the longitudinal axis, and the recesses communicating with each other via the channel are spaced in the direction of the longitudinal axis. In particular the communicating recesses can belong to different circumferential grooves.

The subject matter of the invention is also a linear compressor in which a bearing bush, and/or a gas thrust bearing as defined above is used.

Further features and advantages of the invention emerge from the description of exemplary embodiments given below, which refers to the enclosed figures. The figures are as follows:

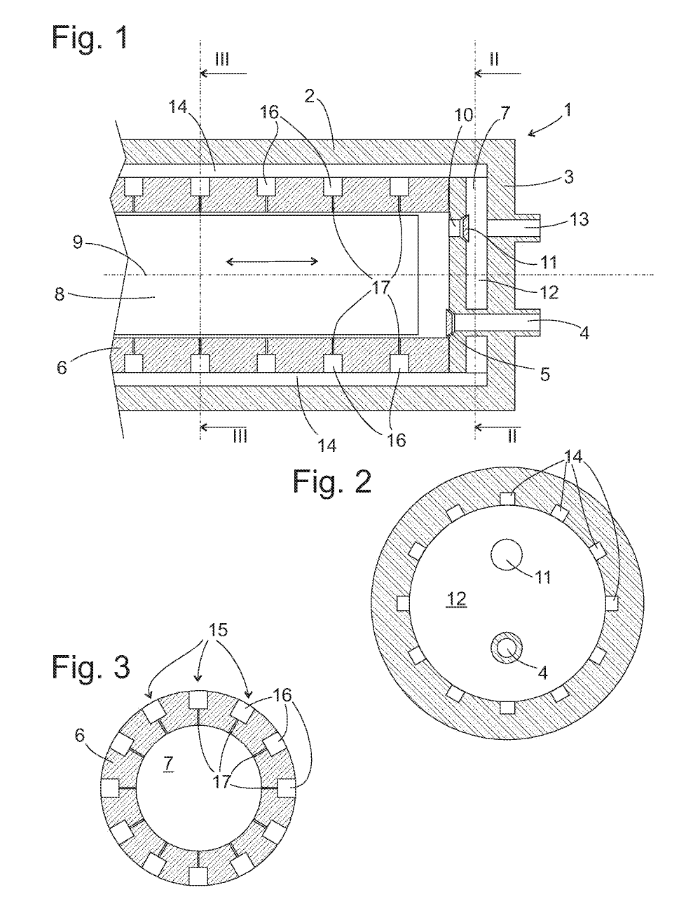

FIG. 1 a schematic axial section through an inventive linear compressor;

FIG. 2 a radial section through the linear compressor along the plane depicted in FIG. 1 by II-II;

FIG. 3 a section through the bearing bush of the linear compressor along the section depicted in FIG. 3 with Ill-Ill in accordance with a first embodiment;

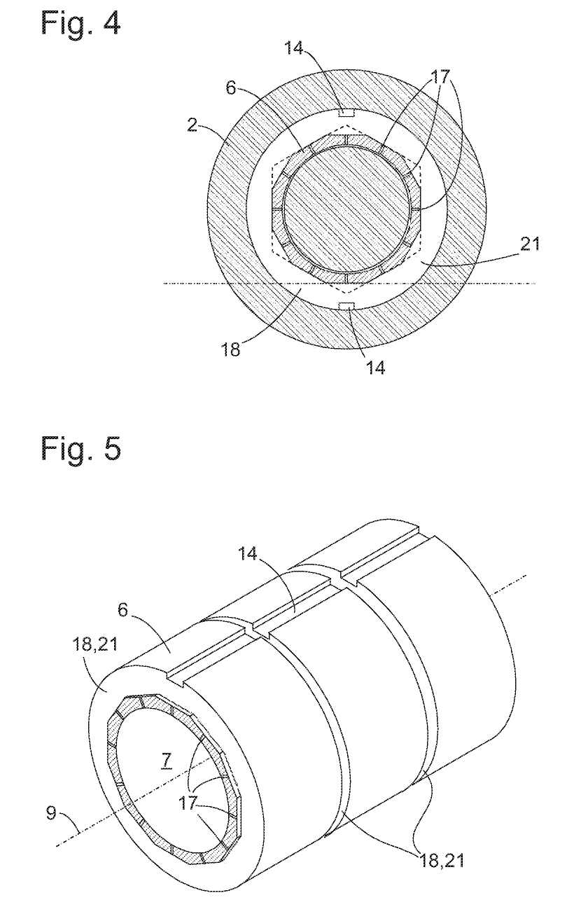

FIG. 4 a radial section through a linear compressor in accordance with a second embodiment;

FIG. 5 a perspective part section of the bearing bush in accordance with the second embodiment; and

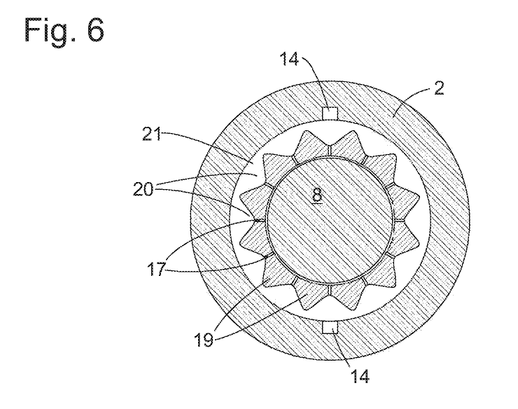

FIG. 6 a section similar to that depicted in FIG. 4 in accordance with a third embodiment of the invention.

The linear compressor shown in FIG. 1 has a housing 1 with a cylindrical cover 2, which is closed off at one end by an end wall 3. A suction connection 4 with a non-return valve 5 extends through the end wall 3 into an inner cavity of the housing 1. Arranged in this cavity adjacent to an inner surface of the cover 2 is a cylindrical bearing bush 6, which together with end wall 3 delimits a working chamber 7. In this chamber a piston 8 is able to be moved in the direction of the longitudinal axis 9 of the bearing bush 6. A movement of the piston 8 away from the end wall 3 sucks a gas to be compressed through the suction connection 4 into the working chamber 7; A movement of the piston 8 towards the end wall 3 compresses the gas and finally pushes it into a pressure outlet 10, in which a second non-return valve 11 is arranged.

Formed downstream from the non-return valve 11 is a distributor chamber 12 in the end wall 3. The greater part of the compressed gas leaves the distributor chamber 12 via a pressure connection 13; A smaller part flows in channels 14, extending along the inner surface of the cover 2 in an axial direction and communicating in each case with a plurality of supply holes 15 extending through the body of the bearing bush 6. The supply holes 15 are each formed by an outer blind hole 16, the depth of which is precisely dimensioned, in order to guarantee a spacing between the floor of each blind hole 16 and an inner side of the sleeve a residual wall thickness of 0.6 mm for example. A capillary hole 17 with a diameter of for example 30 μm extends from the floor of each blind hole 16 through the body of the bearing bush 6 into the working chamber 7. Compressed gas moves via the capillary holes 17 from the distributor chamber 12 back into the working chamber 7, where it forms a gas cushion, which holds the piston 8 floating without contact with the bearing bush 6 and thus enables an essentially frictionless movement of the piston 8.

FIG. 2 shows a section through the end wall 3 of the compressor at the height of the distributor chamber 12. Any number of channels 14 exiting from this chamber can in principle be provided for feeding all supply holes 15 with compressed gas, as is shown in some cases by dashed outlines.

FIG. 3 shows a radial section through the bearing bush 6 along the plane Ill-Ill of FIG. 1. A plurality of supply holes 15, twelve in this diagram, is distributed evenly over the circumference of the bearing bush 6. To feed these as well as other supply holes 15 lying in planes parallel to the sectional plane, the channels 14 are distributed in appropriate numbers on the inner side of the cover 2 and are connected to the distributor chamber 12.

FIG. 4 shows a section along the plane Ill-Ill in accordance with a second embodiment of the invention. A plurality of narrow circle-segment-shaped recesses 18 are formed by milling or sawing on the outer surface of the bearing bush 6, of which one is highlighted for the purposes of illustration by a dotted and dashed delimiting line. The overlapping recesses 18 together forming a groove 21 around the circumference reduce the cross section of the bearing bush 6 in the sectional plane shown to a regular polygon, here a dodecagon, with a capillary hole 17 extending in each case from the middle of each side of the polygon through the body of the bearing bush 6 to the working chamber 7. The polygon shape results in the cross-sectional surface of the bearing bush 6 in the sectional plane and thereby its rigidity being greater than that of a conventional bearing bush in which capillary holes exit from a circumferential groove of constant depth. The growth in the cross-sectional surface is the greater, the smaller the number of corners of the polygon is, as a hexagonal contour shown by a dashed line for comparison illustrates. Since the individual recesses 18 merge with each other at the corners of the polygon and thus form the circumferential groove 21 with variable depth, a small number of channels 14 are sufficient to feed all capillary holes 17. These can extend, as shown in FIG. 2 along the inner surface of the cover 2; In FIG. 4 they are formed in the bearing bush 6 itself, as the recesses 18 by milling or sawing. Instead of the two channels 14 shown in FIG. 4 a single channel can also suffice.

FIG. 5 shows for the purposes of illustration a perspective view of a bearing bush 6 in cross section with a circumferential groove 21 formed at the height of one of the recesses 18. A number of axially spaced circumferential grooves 21 and the channels 14 connecting them to each other and to the distribution chamber 12 can be seen.

According to a third embodiment shown in FIG. 6 axially spaced circumferential grooves 21, of which one can be seen in section in the figure, are formed on the outer surface of the bearing bush 6 by rotary processing with a rotating milling tool oscillating in the radial direction of the bearing bush 6. By setting the oscillating frequency of the milling tool to twelve times the rotary frequency of the bearing bush 6 a toothed-wheel like cross-sectional shape with twelve teeth 19 and twelve tooth gaps 20 is obtained. After the wall thickness of the bearing bush 6 has been reduced by rotary processing at the lowest points of the tooth gaps 20 to the desired dimension of 0.6 mm, the capillary holes 17 are inserted at these points. The respective intermediate teeth 19 guarantee a large cross-sectional surface of the bearing bush 6 in the cross-sectional plane and thereby a high degree of dimensional stability. A channel 14 to supply the capillary holes 17 with compressed gas can, as is shown in FIG. 2, extend along the inner surface of the cover 2 or extend as a hole through the cover 2 or, as shown in FIG. 4 and 5, be milled or sawn into the bearing bush 6. It is also conceivable to process the outer surface of the bearing bush 6 over its entire length with the oscillating cutting tool, in order in this way to create longitudinal channels 14 in each case between strips remaining unworked, which connect the circumferential grooves 21 to the distributor chamber.

1-13. (canceled)

14. A gas thrust bearing comprising:
a bearing bush: and
a housing accommodating the bearing bush,
wherein the bearing bush includes:
a bush body defining a longitudinal axis, wherein the bush body includes:
a plurality of recesses formed on an outer surface of the bush body; and
a plurality of capillary holes extending from a floor of each recess of the plurality of recesses through the bush body to an inner surface of the bush body,
wherein a cross section of the bush body transverse to the longitudinal axis, through each of the plurality of capillary holes, has a local wall thickness that is greater than a wall thickness in an immediate environment of the capillary hole.

15. The gas thrust bearing as claimed in claim 14, wherein the recesses are blind holes,
wherein the diameter of each of the blind holes is greater than a diameter of each of the plurality of capillary holes, and
wherein each of the plurality of capillary holes starts from a floor surface of each of the blind holes.

16. The gas thrust bearing as claimed in claim 14, wherein the outer surface of the bush body is a cylindrical outer surface, and
wherein the recesses are circle-segment-shaped cutouts on the cylindrical outer surface of the bush body.

17. The gas thrust bearing as claimed in claim 16, wherein each of the plurality of capillary holes exits centrally in the cross section transverse to the longitudinal axis of the bush body from a floor surface of each of the circle-segment-shaped cutouts.

18. The gas thrust bearing as claimed in claim 16, wherein each of a number of the circle-segment-shaped cutouts merge into a groove running around the outer surface of the bush body.

19. The gas thrust bearing as claimed in claim 17, wherein a cross-section of the floor surface of each of the circle-segment-shaped cutouts forms a regular polygon.

20. The gas thrust bearing as claimed in claim 14, wherein the plurality of recesses are part of at least one groove running around the outer surface of the bush body with variable depth in the circumferential direction.

21. The gas thrust bearing as claimed in claim 14, wherein a cross section of the bush body transverse to the longitudinal axis has a shape of a toothed wheel,
wherein the toothed wheel has teeth and spaces between the teeth, and
wherein each of the plurality of capillary holes exits from one of the spaces between the teeth.

22. The gas thrust bearing as claimed in claim 21, wherein a cross section of the teeth and the spaces between the teeth forms a curved contour.

23. The gas thrust bearing as claimed in claim 21, wherein the toothed wheel shape is created by a metal cutting production method.

24. The gas thrust bearing as claimed in claim 14, wherein at least one channel is formed on an inner surface of the housing, and
wherein a number of the plurality of recesses communicate via the at least one channel.

25. The gas thrust bearing as claimed in claim 24, wherein the at least one channel is extended in a direction of the longitudinal axis, and
wherein the recesses communicating with each other via the channel are spaced in the direction of the longitudinal axis.

26. The linear compressor, comprising the gas thrust bearing as claimed in claim 14.

27. The gas thrust bearing as claimed in claim 23, wherein the metal cutting production method includes turning the toothed wheel with an oscillating rotary cutter.
